(19) United States
(12) Patent Application Publication
(10) Pub. No.: US 2023/0136133 A1
(43) Pub. Date: May 4, 2023

(54) PARKING ASSISTANCE SYSTEM, PARKING ASSISTANCE DEVICE, PARKING ASSISTANCE METHOD, AND NON-TRANSITORY COMPUTER READABLE MEDIUM

(71) Applicant: DENSO CORPORATION, Kariya-city (JP)

(72) Inventors: Takamasa HIDAKA, Kariya-city (JP); Koudai Yamaura, Kariya-City (JP); Masatake Wada, Kariya-City (JP)

(21) Appl. No.: 18/147,917

(22) Filed: Dec. 29, 2022

Related U.S. Application Data
(63) Continuation of application No. PCT/JP21/23041, filed on Jun. 17, 2021.

(30) Foreign Application Priority Data
Jul. 16, 2020 (JP) 2020-122104

(51) Int. Cl. B60W 30/06; B60W 60/00; G01C 21/34

(52) U.S. Cl. CPC B60W 30/06; B60W 60/001; G01C 21/3415; B60W 2552/05; B60W 2556/40

(57) ABSTRACT

A parking assistance system configured to assist in automatic valet parking of a vehicle includes an autonomous vehicle configured to perform autonomous driving between a boarding-alighting area and a parking area in a parking lot; and a management device configured to manage entering and exiting of an autonomous vehicle in the parking lot. The management device includes a route generation unit configured to generate a guide route from the boarding-alighting area to the parking area. A map provision unit in the management device is configured to extract a route map indicative of a portion of parking lot map information regarding the guide route and to provide the route map to the autonomous vehicle.

### CROSS REFERENCE TO RELATED APPLICATIONS

The present application is a continuation application of International Patent Application No. PCT/JP2021/023041 filed on Jun. 17, 2021, which designated the U.S. and claims the benefit of priority from Japanese Patent Application No. 2020-122104 filed on Jul. 16, 2020. The entire disclosures of all of the above applications are incorporated herein by reference.

### TECHNICAL FIELD

The present disclosure relates to a parking assistance system, a parking assistance device, a parking assistance method, and a non-transitory computer readable medium storing a parking assistance program configured to assist in automatic valet parking of a vehicle.

### BACKGROUND

As a parking assistance system, an automatic valet parking technique is well-known in which a management device on a parking lot side guides an autonomous vehicle from an alighting area to a parking area within a parking area.

### SUMMARY

One aspect of the present disclosure provides a parking assistance system configured to assist in automatic valet parking of a vehicle. The parking assistance system includes an autonomous vehicle configured to perform autonomous driving between a boarding-alighting area and a parking area in a parking lot; and a management device configured to manage entering and exiting of an autonomous vehicle in the parking lot.

The management device includes a route generation unit, a map provision unit, and a route provision unit. The route generation unit configured to generate a guide route from the boarding-alighting area to the parking area that is a target position when a entering instruction for entering the autonomous vehicle is input while the autonomous vehicle is located in the boarding-alighting area.

The map provision unit is configured to extract a route map representing parking lot map information of a portion related to the guide route from previously prepared parking lot map information including positions of a passage of the parking lot, the boarding-alighting area, and the parking area, and provide the route map to the autonomous vehicle. The route provision unit configured to provide the guide route to the autonomous vehicle.

The map provision unit is a first provision unit. The management device further includes a second provision unit configured to provide the autonomous vehicle with a near-side map representing parking lot map information of a portion from a near-side region set in advance to the boarding-alighting area in the parking lot map information when the autonomous vehicle is located in the near-side region before the entering instruction is input and before the autonomous vehicle arrives at the boarding-alighting area.

### BRIEF DESCRIPTION OF DRAWINGS

FIG. 1 is a top view illustrating an example of a parking lot.

FIG. 2 is a block diagram illustrating a configuration of a parking assistance system.

FIG. 3 is a functional block diagram of a control unit of a management device.

FIG. 4 is a flowchart illustrating a movement management process executed by the management device.

FIG. 5 is a flowchart illustrating a movement setting process executed by the management device.

FIG. 6 is a flowchart illustrating an automatic parking process executed by an autonomous vehicle.

FIG. 7 is a flowchart illustrating a map information update process executed by the autonomous vehicle.

FIG. 8A is a diagram exemplifying the entire route of the parking lot map information regarding a guide route.

FIG. 8B is a diagram illustrating a first portion of the parking lot map information regarding the guide route.

FIG. 8C is a diagram illustrating a second portion of the parking lot map information regarding the guide route.

FIG. 8D is a diagram illustrating a third portion of the parking lot map information regarding the guide route.

FIG. 9A is a top view illustrating an example of division of parking lot map information regarding a guide route.

FIG. 9B is a diagram illustrating the first portion of the parking lot map information regarding the guide route.

FIG. 9C is a diagram illustrating the second portion of the parking lot map information regarding the guide route.

### DESCRIPTION OF EMBODIMENTS

To begin with, a relevant technology will be described first only for understanding the following embodiments.

Typically, an autonomous vehicle is configured to travel along a guide route transmitted from the management device.

In the above technique, it is preferable that the autonomous vehicle is provided with parking lot map information indicating positions of passages and the like in the parking lot such that the autonomous vehicle can travel safely. However, as a result of detailed studies by the inventor, a problem has been found in which parking lot map information has a huge amount of data, and if all of the parking lot map information is stored in an autonomous vehicle, and a capacity of a memory of the autonomous vehicle becomes tight.

One aspect of the present disclosure is to achieve a technique that in a parking assistance system configured to assist in automatic valet parking of a vehicle, when parking lot map information is stored in an autonomous vehicle, a capacity of a memory of the autonomous vehicle is less likely to be tight.

A first aspect of the present disclosure is a parking assistance system configured to assist in automatic valet parking of a vehicle. The parking assistance system includes an autonomous vehicle configured to perform autonomous driving between a boarding-alighting area and a parking area in a parking lot; and a management device configured to manage entering and exiting of the autonomous vehicle in the parking lot. The management device includes: a route generation unit configured to generate a guide route from the boarding-alighting area to the parking area that is a target position when an entering instruction for the autonomous vehicle to park is input while the autonomous vehicle is located in the boarding-alighting area; a map provision unit configured to (i) extract a route map from previously prepared parking lot map information including position information of a passage of the parking lot, the boarding-alighting area, and the parking area and (ii) provide the route map to the autonomous vehicle, the route map being indicative of a portion of the parking lot map information regarding the guide route; and a route provision unit configured to provide the guide route to the autonomous vehicle. The map provision unit is a first provision unit, and the management device further includes a second provision unit configured to provide the autonomous vehicle with a near-side map indicative of a portion of the parking lot map information from a near-side region set in advance to the boarding-alighting area when the autonomous vehicle is located in the near-side region and before the entering instruction is input and the autonomous vehicle arrives at the boarding-alighting area.

A second aspect of the present disclosure is a parking assistance device configured to assist in automatic valet parking of a vehicle. The vehicle is an autonomous vehicle configured to perform autonomous driving between a boarding-alighting area and a parking area in a parking lot. The parking assistance device includes: a route generation unit configured to generate a guide route from the boarding-alighting area to the parking area that is a target position when a entering instruction for the autonomous vehicle to park is input while the autonomous vehicle is located in the boarding-alighting area; a map provision unit configured to (i) extract a route map from previously prepared parking lot map information including position information of a passage of the parking lot, the boarding-alighting area, and the parking area and (ii) provide the route map to the autonomous vehicle, the route map being indicative of a portion of the parking lot map information regarding the guide route; and a route provision unit configured to provide the guide route to the autonomous vehicle. The map provision unit is a first provision unit, and the management device further includes a second provision unit configured to provide the autonomous vehicle with a near-side map indicative of a portion of the parking lot map information from a near-side region set in advance to the boarding-alighting area when the autonomous vehicle is located in the near-side region and before the entering instruction is input and the autonomous vehicle arrives at the boarding-alighting area.

A third aspect of the present disclosure is a parking assistance method executed by a parking assistance device configured to assist in automatic valet parking of a vehicle. The vehicle is an autonomous vehicle configured to perform autonomous driving between a boarding-alighting area and a parking area in a parking lot. The parking assistance method includes: generating a guide route from the boarding-alighting area to the parking area that is a target position when an entering instruction for the autonomous vehicle to park is input while the autonomous vehicle is located in the boarding-alighting area; extracting a route map from previously prepared parking lot map information including position information of a passage of the parking lot, the boarding-alighting area, and the parking area and providing the route map to the autonomous vehicle, the route map being indicative of a portion of the parking lot map information regarding the guide route; and providing the guide route to the autonomous vehicle; and providing the autonomous vehicle with a near-side map indicative of a portion of the parking lot map information from a near-side region set in advance to the boarding-alighting area when the autonomous vehicle is located in the near-side region and before the entering instruction is input and the autonomous vehicle arrives at the boarding-alighting area.

A fourth aspect of the present disclosure is a non-transitory computer readable medium storing a parking assistance program executed by a computer mounted in a parking assistance device that is configured to assist in automatic valet parking of a vehicle. The vehicle is an autonomous vehicle configured to perform autonomous driving between a boarding-alighting area and a parking area in a parking lot. The parking assistance program includes instructions, when executed by the computer, causing the computer to: generate a guide route from the boarding-alighting area to the parking area that is a target position when an entering instruction for the autonomous vehicle to park is input while the autonomous vehicle is located in the boarding-alighting area; extract a route map from previously prepared parking lot map information including position information of a passage of the parking lot, the boarding-alighting area, and the parking area, the route map being indicative of a portion of the parking lot map information regarding the guide route; provide the route map to the autonomous vehicle; provide the guide route to the autonomous vehicle; and provide the autonomous vehicle with a near-side map indicative of a portion of the parking lot map information from a near-side region set in advance to the boarding-alighting area when the autonomous vehicle is located in the near-side region and before the entering instruction is input and the autonomous vehicle arrives at the boarding-alighting area.

According to such a configuration, the management device transmits only the route map related to the guide route in the parking lot map information to the autonomous vehicle, and thus the autonomous vehicle does not need to store all of the parking lot map information. Therefore, when the parking lot map information is stored in the autonomous vehicle, it is possible to restrict the capacity of the memory of the autonomous vehicle from becoming tight.

### 1. Embodiment

[1-1. Configuration of Parking Assistance System 1]

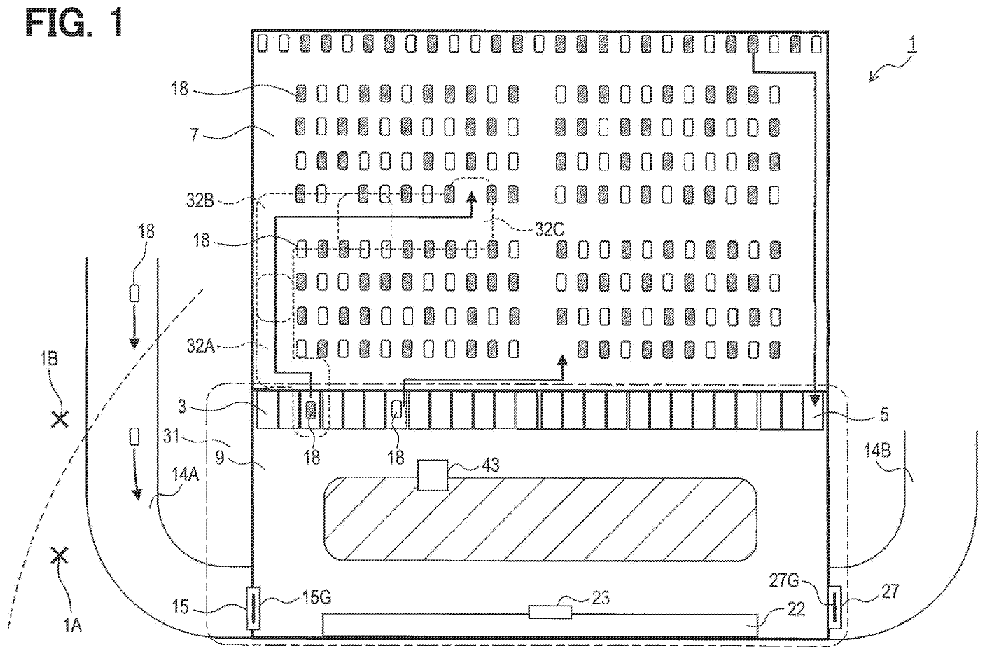

A configuration of a parking assistance system 1 will be described with reference to FIGS. 1 to 3. As illustrated in FIG. 1, the parking assistance system 1 includes a vehicle entering section 3 set as an alighting area where a user gets off, and a vehicle exiting section 5 set as a boarding area where the user gets on, a parking area 7, and a rotary 9. Hereinafter, a region including the vehicle entering section 3, the vehicle exiting section 5, the parking area 7, and the rotary 9 will also be referred to as the parking lot. The vehicle entering section 3 and the vehicle exiting section 5 will be collectively referred to as boarding-alighting areas 3 and 5.

The parking lot and the outside of the parking lot are separated by an entrance gate 15G disposed at an entrance 15 and an exit gate 27G disposed at an exit 27. An entrance road 14A and an exit road 14B are respectively connected to the outside of the entrance 15 and the outside of the exit 27.

An autonomous vehicle 18 that uses the parking lot travels along the entrance road 14A and approaches the entrance 15 with manual driving that is driving by a user. Before the autonomous vehicle 18 arrives at the entrance 15, the autonomous vehicle 18 enters from an impossible region 1B where communication with the management device 39 of the parking assistance system 1 is impossible into a possible region 1A where communication with the management device 39 is possible. The inside of the parking lot is set to the possible region 1A. In FIG. 1, a boundary between the impossible region 1B and the possible region 1A is illustrated only around the entrance 15, but the possible region 1A is set to include the entire parking lot. In the present embodiment, the region from the entrance road 14A to the entrance 15 is described as a region where the vehicle moves with manual driving, but the vehicle may move with autonomous driving.

When the autonomous vehicle 18 enters the possible region 1A, the management device 39 and the autonomous vehicle 18 start communication before the autonomous vehicle 18 arrives at the entrance gate 15G. When this communication is started, the management device 39 performs various determinations such as whether the autonomous vehicle 18 can be parked in the parking lot by using an automatic valet parking function.

As a result of various determinations, if parking is possible, the management device 39 opens the entrance gate 15G and permits the autonomous vehicle 18 to enter the parking lot. The autonomous vehicle 18 enters the rotary 9 after passing through the entrance gate 15G. The rotary 9 is a region that connects a parking region other than the parking area 7 of the parking lot, that is, the vehicle entering section 3, the vehicle exiting section 5, the entrance 15, and the exit 27, and is a region where the autonomous vehicle 18 can move freely without receiving instructions from the management device 39. The autonomous vehicle 18 travels on the rotary 9 with manual driving. The possible region 1A in the regarding outside the parking lot and the rotary 9 correspond to a near-side region in the present disclosure.

In the present embodiment, the rotary 9 is described as a region where the autonomous vehicle 18 moves with manual driving, but may move with autonomous driving. The vehicle entering section 3 and the vehicle exiting section 5 are each provided with multiple sections. The autonomous vehicle 18 moves to a section of the vehicle entering section 3 specified by the management device 39.

The autonomous vehicle 18 has an automatic valet parking function. The automatic valet parking function includes a function of traveling from the vehicle entering section 3 to a parking position in the parking area 7 and parking and a function of traveling from the parking position in the parking area 7 to the vehicle exiting section 5 with autonomous driving. In other words, the autonomous vehicle 18 only needs to be able to perform the automatic valet parking function in the vehicle entering section 3, the vehicle exiting section 5, and the parking area 7, and does not need to have the function of performing autonomous driving outside the parking lot and inside the rotary 9. Alternatively, the autonomous vehicle 18 may have the function of performing autonomous driving outside the parking lot and inside the rotary 9.

The automatic valet parking function includes particularly a function of repeatedly acquiring position information of the autonomous vehicle 18 and transmitting the position information to the management device 39 that is a parking assistance device of the present disclosure, and a function of receiving a guide route from the management device 39 and controlling the autonomous vehicle 18 to travel along the guide route. The position information of the autonomous vehicle 18 indicates an estimation result of the current location of the autonomous vehicle 18, and includes, for example, coordinate values in a region of the parking lot.

The guide route includes position information of nodes that the autonomous vehicle 18 is required to pass through and markers that are detected when the autonomous vehicle 18 travels along the nodes. The marker is also called a landmark and is, for example, a two-dimensional barcode. The marker is disposed on a road surface or wall surface in the parking lot. The marker has, for example, a rectangular shape. The position information of the markers included in the guide route represents position information of four corners of the rectangular markers. The guide route may include information regarding a set speed when the autonomous vehicle 18 passes through the node.

The vehicle entering section 3 and the vehicle exiting section 5 are adjacent to an entrance 23 of a facility 22 such as a store. In the present embodiment, the vehicle entering section 3 and the vehicle exiting section 5 are disposed with the rotary 9 separated from the entrance 23. An occupant of the autonomous vehicle 18 loaded into the vehicle entering section 3 can get off the autonomous vehicle 18 and proceed to the entrance 23 on foot. The occupant can proceed to the vehicle exiting section 5 from the entrance 23 of the facility 22 on foot.

The vehicle exiting section 5 is disposed closer to the exit 27 than the vehicle entering section 3. The autonomous vehicle 18 can move from the vehicle exiting section 5 to the outside of the parking lot through the rotary 9 and the exit gate 27G with manual driving by the user. The management device 39 opens the exit gate 27G to the autonomous vehicle 18 for which the payment of a parking fee for the parking lot has been completed. After passing through the exit gate 27G, the autonomous vehicle 18 can travel on the exit road 14B and head for a destination. While traveling on the exit road 14B, the autonomous vehicle 18 moves from the possible region 1A where communication with the management device 39 is possible to the impossible region 1B where communication is impossible.

The parking area 7 is a place in which multiple autonomous vehicles 18 can be parked. Multiple sections are provided in the parking area 7. Each section provided in the vehicle entering section 3, the vehicle exiting section 5, and the parking area 7 is a region in which one autonomous vehicle 18 can be parked. The autonomous vehicle 18 can travel from the vehicle entering section 3 to the parking area 7. The autonomous vehicle 18 can travel from the parking area 7 to the vehicle exiting section 5.

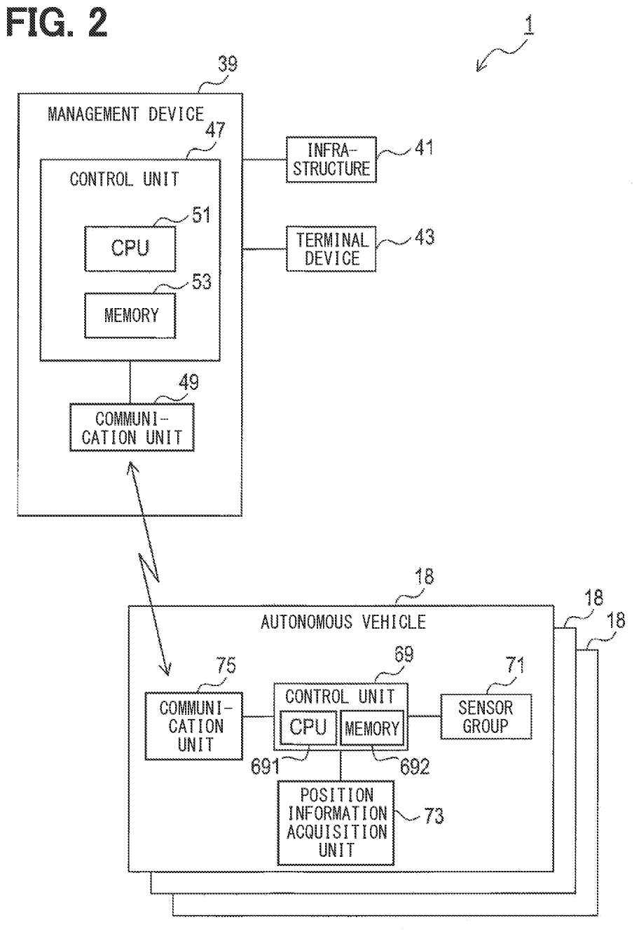

As illustrated in FIG. 2, the parking assistance system 1 includes the management device 39, an infrastructure 41, and a terminal device 43. The management device 39 includes a control unit 47 and a communication unit 49. The control unit 47 includes a microcomputer including a CPU 51 and, for example, a semiconductor memory (hereinafter referred to as a memory 53) such as a RAM or a ROM. The management device 39 can manage multiple autonomous vehicles 18.

Each function of the control unit 47 is realized by the CPU 51 executing a program stored in a non-transitory tangible storage medium. The program includes a parking assistance program of the present disclosure. In this example, the memory 53 corresponds to a non-transitory tangible storage medium storing the program. A method corresponding to the program is executed by executing the program. The control unit 47 may include one microcomputer or multiple microcomputers.

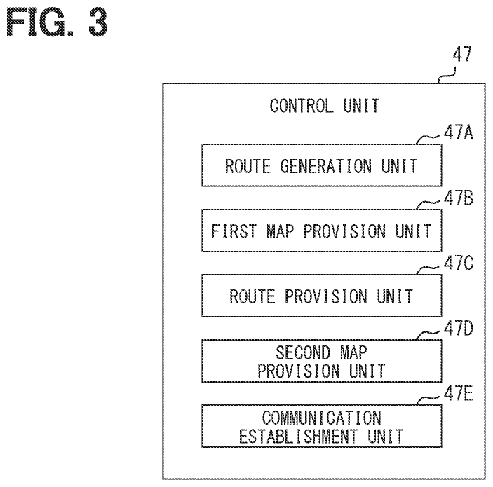

The control unit 47 has a configuration for transmitting, to the autonomous vehicle 18, a guide route to a target position such as a parking position in the parking area 7, an exiting position, map information of the parking lot, a parking start instruction, and an exiting start instruction. For example, as illustrated in FIG. 3, the control unit 47 includes a route generation unit 47A, a first map provision unit 47B, a route provision unit 47C, a second map provision unit 47D, and a communication establishment unit 47E. An operation of each of the units 47A to 47E forming the control unit 47 will be described later. The first map provision unit 47B of the present embodiment corresponds to a first provision unit of the present disclosure, and the second map provision unit 47D of the present embodiment corresponds to a second provision unit of the present disclosure.

The memory 53 stores parking lot map information that is map information of the parking lot. The parking lot map information also includes information representing a state of a section in the parking area 7. As the state of the section, there are an empty state (hereinafter referred to as an empty state) and a state occupied by the autonomous vehicle 18 (hereinafter referred to as an occupied state). The communication unit 49 can perform communication with the autonomous vehicle 18.

In addition to the above information, the map information includes, for example, position information of a parking frame, position information of a node, a link, and an obstacle in the parking lot, position information of a marker, and information indicating a travel boundary referred to when the autonomous vehicle 18 estimates its own position.

The infrastructure 41 has a function of acquiring information (hereinafter referred to as in-parking lot information) representing an internal situation of the parking assistance system 1 and providing the in-parking lot information to the management device 39. The infrastructure 41 includes a camera, a lidar, and the like that capture images of the inside of the parking lot.

Examples of the in-parking lot information include information representing a position of an obstacle, information representing a state of a section in the parking area 7, and position information of the autonomous vehicle 18 present in the parking assistance system 1.

As illustrated in FIG. 1, the terminal device 43 is installed in the vicinity of the vehicle entering section 3. The terminal device 43 outputs a parking request signal in response to an input operation, for example, a parking request that is the intention of a user to load the autonomous vehicle 18. The parking request signal is a signal for requesting that the autonomous vehicle 18 in the vehicle entering section 3 is transported to the parking area 7 and parked therein. When the terminal device 43 outputs a signal corresponding to the input operation to the management device 39, the terminal device 43 outputs identification information and the like of the autonomous vehicle 18.

The terminal device 43 outputs an exiting request signal in response to an input operation, for example, an exiting request that is the intention of the user to unload the autonomous vehicle 18. The exiting request signal is a signal for requesting that the autonomous vehicle 18 parked in the parking area 7 is guided to the vehicle exiting section 5.

The terminal device 43 outputs identification information of the autonomous vehicle 18 in response to an input operation, for example. The identification information is, for example, information such as a number plate for uniquely specifying the autonomous vehicle 18.

The terminal device 43 may be configured as a mobile terminal device such as a smart phone owned by the user, for example. Hereinafter, the parking request and the exiting request will be collectively referred to as a movement request, and the parking request signal and the exiting request signal will be collectively referred to as a movement request signal.

As described above, the autonomous vehicle 18 has an automatic valet parking function. As illustrated in FIG. 2, the autonomous vehicle 18 includes a control unit 69, a sensor group 71, a position information acquisition unit 73, and a communication unit 75.

The control unit 69 includes a microcomputer including a CPU 691 and, for example, a semiconductor memory (hereinafter referred to as a memory 692) such as a RAM or a ROM. The control unit 69 controls each unit of the autonomous vehicle 18. The control unit 69 performs control for realizing the autonomous driving function. Functions executed by the control unit 69 include functions as a storage unit and a deletion unit in the present disclosure. These functions will be described later.

The autonomous vehicle 18 acquires the map information of the parking lot and the guide route from the management device 39, and uses the map information of the parking lot and the guide route when autonomous driving is performed.

The sensor group 71 acquires peripheral information representing a peripheral situation of the autonomous vehicle 18. Examples of details of the peripheral information include a position of an obstacle present around the autonomous vehicle 18. The sensor group 71 includes, for example, a camera and a lidar. The autonomous vehicle 18 uses the peripheral information when performing autonomous driving.

The position information acquisition unit 73 acquires the position information of the autonomous vehicle 18. The position information acquisition unit 73 is, for example, a position estimation system based on a lidar and map information. The autonomous vehicle 18 uses the position information when performing autonomous driving. The communication unit 75 can perform communication with the management device 39.

[1-2. Process]

[1-2-1. Movement Management Process Executed by Management Device 39]

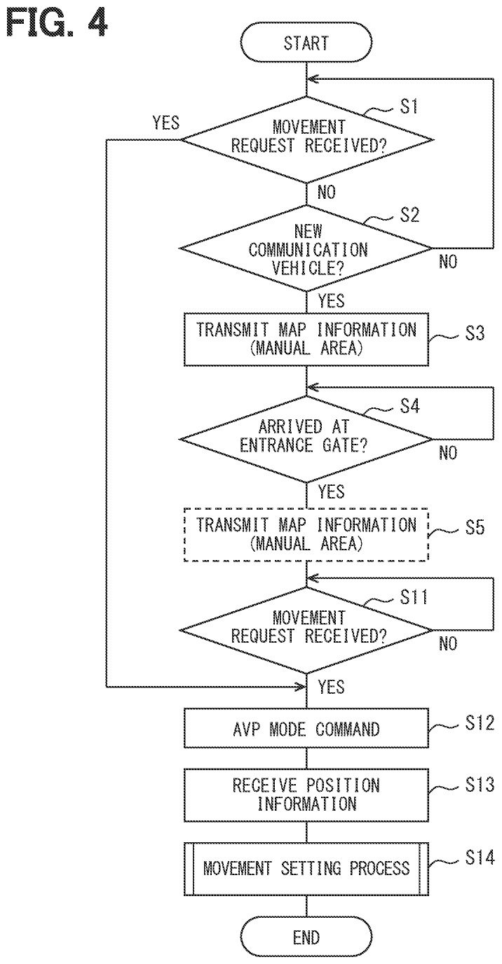

A movement management process executed by the management device 39 will be described with reference to FIG. 4. The movement management process is, for example, a process that is started when the management device 39 is powered on, and then repeatedly executed. The processes after step (hereinafter referred to as “S”) 2 in the present process are executed for each autonomous vehicle 18 that has requested movement. Hereinafter, a process executed by the control unit 47 (particularly the CPU 51) of the management device 39 will also be referred to as a process executed by the management device 39.

The management device 39 determines whether a movement request signal has been received in S1 of the movement management process illustrated in FIG. 4. If the movement request signal has been received, the process proceeds to S12. If the movement request signal has not been received, the process proceeds to S2.

When a user such as an occupant of the autonomous vehicle 18 inputs a movement request corresponding to a parking request of the present disclosure by operating the terminal device 43 after getting off the vehicle, the terminal device 43 transmits a movement request signal corresponding to this input to the management device 39. In this case, the user inputs vehicle information such as a number plate for specifying the vehicle, user information such as a user ID and a password for specifying the user, and other necessary types of information, to the terminal device 43.

When the terminal device 43 is operated, unique information such as an identification ID for specifying the terminal device 43, the vehicle information, and the user information is transmitted to the management device 39. After performing operation for the movement request, the user can leave the parking lot and head for a destination such as the facility 22.

Subsequently, in S2, the communication establishment unit 47E of the management device 39 determines whether the autonomous vehicle 18 that is performing communication is a new communication vehicle that is about to be parked, that is, whether the vehicle has entered the possible region 1A where communication is possible from the impossible region 1B where communication is impossible. The communication establishment unit 47E is configured to establish communication with the autonomous vehicle 18 that has entered the possible region 1A.

When it is determined in S2 that the vehicle is not a new communication vehicle, the process returns to 51. When it is determined in S2 that the vehicle is a new communication vehicle, in S3 the second map provision unit 47D of the management device 39 extracts a near-side map from the memory 53 and provides the near-side map to the autonomous vehicle 18. The near-side map will also be referred to as near-side map information. The process in S3 is performed before a entering intention such as a parking request is input and before the autonomous vehicle 18 arrives at the boarding-alighting areas 3 and 5. The entering intention is an example of a entering instruction.

The near-side map is part of the parking lot map information, and is map information regarding a region including the entire rotary 9 (for example, a region 31 illustrated in FIG. 1). In the present embodiment, the second map provision unit 47D extracts data corresponding to the near-side map from the parking lot map information in which the entire parking lot is collected as one piece of data. However, as the parking lot map information, the near-side map and a map of other portions (for example, multiple divided maps or map information of the parking area 7) may be separated in advance as separate data and stored in the memory 53. In this case, the second map provision unit 47D may extract the near-side map separated in advance.

The memory 53 may store the near-side map information and multiple pieces of divided map information. Alternatively, the memory 53 may store the near-side map information and map information corresponding to the parking area 7. When the memory 53 stores the map information corresponding to the parking area 7, the first map provision unit 47B extracts or creates multiple divided maps corresponding to the parking area 7 from the map information based on the guide route set for the autonomous vehicle 18.

The parking lot map information includes positions of a passage of the parking lot, the boarding-alighting areas 3 and 5, and the parking area 7, and the passage includes information such as nodes and links commonly used in navigation maps. The parking lot map information may include at least a node indicating the position of the passage. By referring to the parking lot map, the autonomous vehicle 18 can recognize positions of passages, obstacles, parking frames, and the like on the map.

However, the near-side map is not map information of the entire parking lot, but map information of the rotary 9. The near-side map includes information such as positions of the boarding-alighting areas 3 and 5, positions of the gates 15G and 27G, and positions of travelable regions in the rotary 9.

The autonomous vehicle 18 that has received the parking lot map information such as the near-side map is configured to store the parking lot map information in the memory 692.

Subsequently, in S4, the management device 39 determines whether the autonomous vehicle 18 has arrived at the entrance gate 15G. The management device 39 may perform the determination by using the position information transmitted from the autonomous vehicle 18, the camera provided at the entrance gate 15G, and the like. The management device 39 receives position information of the autonomous vehicle 18 transmitted from the autonomous vehicle 18 in S42 that will be described later.

When it is determined in S4 that the autonomous vehicle 18 has not arrived at the entrance gate 15G, the present process repeats S4. When it is determined in S4 that the autonomous vehicle 18 has arrived at the entrance gate 15G, in S5, the second map provision unit 47D continues to transmit the near-side map.

The process in S5 may be omitted if the transmission of the near-side map is completed before the autonomous vehicle 18 arrives at the entrance gate 15G. The transmission of the near-side map in S3 may be omitted, and, in this case, the near-side map may be transmitted in S5.

Subsequently, in S11, the management device 39 determines whether a movement request signal has been received. When the movement request signal has not been received, the present process repeats S11. When the movement request signal has been received, the process proceeds to S12. The user parks the autonomous vehicle 18 in the boarding-alighting areas 3 and 5, gets off the vehicle, and then operates the terminal device 43 to input a movement request.

Subsequently, the management device 39 transmits an AVP mode command in S12. The AVP mode command is a command for switching a driving mode of the autonomous vehicle 18 from manual driving by the user to autonomous driving by the control unit 69 of the autonomous vehicle 18. When the autonomous vehicle 18 receives the AVP mode command, the autonomous vehicle 18 makes necessary preparations for autonomous driving, such as activating cameras and sensors necessary for the autonomous driving in the sensor group 71.

Subsequently, the management device 39 receives the position information transmitted from the autonomous vehicle 18 in S13. The management device 39 performs a movement setting process in S14. The movement setting process is a process of generating a guide route and moving the autonomous vehicle 18 to a target position along this guide route. When the movement setting process is ended, the management device 39 ends the movement management process.

[1-2-2. Movement Setting Process]

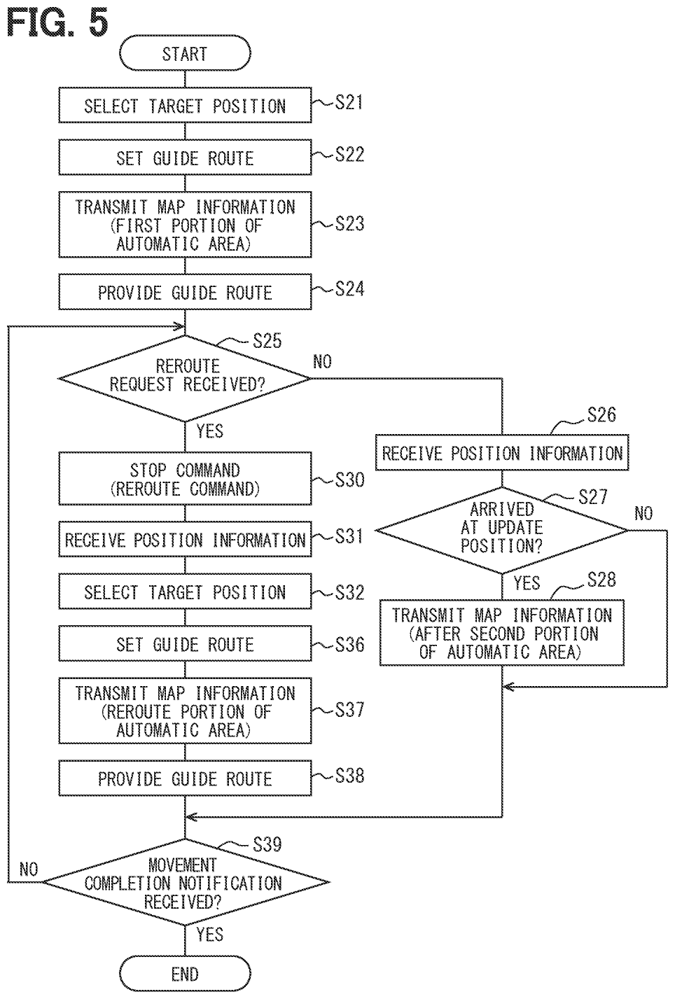

A movement setting process executed by the management device 39 will be described with reference to FIG. 5. In the movement setting process, first, in S21, the management device 39 of the management device 39 selects a target position, here a parking position or an exiting position.

As the parking position, an empty section (vehicle chamber) in the parking area 7 is selected. As the exiting position, an empty section in the vehicle exiting section 5 is selected. For example, the management device 39 determines a state of each section as follows. When the autonomous vehicle 18 is parked in a certain section, the autonomous vehicle 18 sends identification information of the section and parking start information to the management device 39. When the autonomous vehicle 18 leaves the section in which the autonomous vehicle 18 has been parked until then, the autonomous vehicle 18 sends the identification information of the section and parking end information to the management device 39.

The management device 39 determines a state of each section based on the history of information sent from the autonomous vehicle 18. The management device 39 may also determine a state of each partition based on information provided by the infrastructure 41.

When there is only one empty section, the management device 39 selects that section as a parking position. When there are multiple empty sections, the management device 39 selects one of the multiple empty sections as a parking position based on a predetermined criterion. As the criteria, for example, there is a criteria of selecting a section closest to the vehicle entering section 3, a criterion of selecting a section closest to the vehicle exiting section 5, or a criterion of selecting a section in an area where empty sections are gathered.

Subsequently, in S22, the route generation unit 47A of the management device 39 sets a guide route by using the parking lot map information. The management device 39 sets a guide route for the autonomous vehicle 18 to autonomously travel, the guide route being a route from the current location of the autonomous vehicle 18 to the parking position selected in S21.

Subsequently, the first map provision unit 47B sends map information of a first portion 32A out of the parking lot map information to the autonomous vehicle 18. The first map provision unit 47B first extracts a route map (also referred to as partial map information) representing a portion related to the guide route from the parking lot map information.

The portion related to the guide route represents a range within which target objects such as obstacles, markers, and lane lines can be sensed by sensors such as a camera and a sonar of the autonomous vehicle 18. In addition to the passage in the parking area 7, the position of each section of the boarding-alighting areas 3 and 5, and the position of each section of the parking area 7, the route map includes position information of target objects including obstacles, markers, and lane lines that can be sensed by the sensors of the autonomous vehicle 18. The sensors of the autonomous vehicle 18 include sensors that detect a relative distance between the autonomous vehicle 18 and an object around the autonomous vehicle 18.

In the example illustrated in FIG. 1, the route map indicates map information within a range including all ranges indicated by the first portion 32A, a second portion 32B, and a third portion 32C. The first map provision unit 47B does not transmit the entire parking lot map information to the autonomous vehicle 18, but transmits a route map that is at least a part of the parking lot map information and includes the guide route and the sensible range.

Although the management device 39 may transmit the route map without any change, the guide route is divided into multiple routes at predetermined distances to form multiple divided routes. The parking lot map information of the portion related to the divided route is extracted as multiple divided maps obtained by dividing the route map. In the example illustrated in FIG. 1, map information of each of the first portion 32A, the second portion 32B, and the third portion 32C corresponds to a respective one of the multiple divided maps. In the example illustrated in FIG. 1, the multiple divided maps are drawn to partially overlap each other, but the multiple portions may be in contact with each other.

The management device 39 may store an order of providing the multiple divided maps to the autonomous vehicle 18 along the guide route from the current location of the autonomous vehicle 18 to the selected parking position, and update position information that will be described later.

The first map provision unit 47B provides the autonomous vehicle 18 with the multiple divided maps in descending order of distance from a target position in accordance with movement of the autonomous vehicle 18. The first map provision unit 47B transmits only map information of the first portion 32A.

Subsequently, in S24, the route provision unit 47C of the management device 39 uses the communication unit 49 to transmit information representing the guide route set in S22 (hereinafter referred to as guide route information). As will be described later, the autonomous vehicle 18 and other vehicles that are autonomous vehicles 18 other than the autonomous vehicle 18 receive the guide route information and start autonomous driving along the guide route.

Subsequently, in S25, the management device 39 determines whether a reroute request has been received. The reroute request is a request transmitted from another vehicle or from the inside of the management device 39, for example, when the other vehicle stops on the route due to trouble or when the guide route for the autonomous vehicle 18 cannot be used.

When a reroute request has not been received in S25, the management device 39 acquires the position information of the autonomous vehicle 18 in S26. Subsequently, in S27, the management device 39 determines whether the autonomous vehicle 18 has arrived at the update position. The update position is a position set in each of the portions excluding the third portion 32C that is the last portion among the first portion 32A, the second portion 32B, and the third portion 32C, and is a position serving as a trigger to provide map information of the next portion. The last portion indicates a divided map that is provided to the autonomous vehicle 18 last among the first portion 32A, second portion 32B, and third portion 32C.

When it is determined in S27 that the autonomous vehicle 18 has arrived at the update position, the management device 39 transmits the map information of the next portion to the autonomous vehicle 18 in S28. The next portion is a portion farthest from the target position among portions that have not been transmitted.

For example, if the map information of the first portion 32A and the second portion 32B has already been transmitted, the third portion 32C corresponds to the next portion. In this case, the map information of the third portion 32C is transmitted. On the other hand, when the autonomous vehicle 18 has not arrived at the update position in S27, or when S28 has been performed, the process proceeds to S39.

An example in which the first map provision unit 47B provides a route map or a divided map illustrating the parts related to the guide route will be described.

FIGS. 8A, 8B, 8C, and 8D illustrate parking lot map information related to guide routes. As illustrated in FIG. 8A, when the route generation unit 47A generates the guide route from the current location and the target position of the autonomous vehicle 18, the first map provision unit 47B extracts a region related to the guide route from the parking lot map information, and generates partial map information. The region related to the extracted guide route is within a range in which target objects such as obstacles, markers, and lane lines can be sensed by the sensors such as a camera and a sonar of the autonomous vehicle 18.

As described above, the management device 39 may transmit the route map without any change, or may create multiple divided route maps. When the route map is divided into multiple routes, the route map may be divided based on a predetermined distance, or may be divided based on a data capacity (file size) of the route map. For example, when a data capacity of the partial map information is less than a predetermined reference value, the entire route map as illustrated in FIG. 8A is transmitted to the autonomous vehicle 18 without dividing the partial map information.

On the other hand, when the data size of the partial map information is greater than the predetermined reference value, the partial map information is divided such that the data size of one divided map is smaller than the reference value, such as divided maps 32D, 32E, and 32F illustrated in FIGS. 8B to 8D. The predetermined reference value is, for example, a file size of map information that can be stored by the autonomous vehicle 18 or a size of the in-vehicle memory of the autonomous vehicle 18. In this case, the management device 39 transmits the divided maps 32D, 32E, and 32F to the autonomous vehicle 18 in the order of the divided maps 32D, 32E, and 32F as the autonomous vehicle 18 moves toward the target position.

By the way, when it is determined in S25 that a reroute request has been received, the process proceeds to S30. The management device 39 transmits a stop command to the autonomous vehicle 18 in S30. That is, when receiving the reroute request, the management device 39 transmits the stop command to the autonomous vehicle 18 before setting a new target position. In this case, the management device 39 transmits the stop command without determining a traveling state of the autonomous vehicle 18. The autonomous vehicle 18 stops the autonomous vehicle 18 immediately after receiving the stop command.

However, the management device 39 may transmit the stop command only when necessary, such as when a traveling direction changes. In this case, after the guide route is set in S36 that will be described later, the stop command may be transmitted as necessary. When the stop command is not sent, it is preferable to send a reroute command to reroute.

Subsequently, in S31, the management device 39 receives the position information. The present process is similar to S26. Subsequently, in S32, the management device 39 selects a target position. The present process is similar to S21, and may be omitted when the target position is not changed.

Subsequently, in S36, the route generation unit 47A sets a guide route. The present process is similar to S22. Subsequently, in S37, the parking lot map information is transmitted. The parking lot map information transmitted here is parking lot map information related to the guide route after the rerouting, and may be a part of divided parking lot map information. Subsequently, in S38, the management device 39 provides the guide route. The present process is similar to S24.

Subsequently, in S39, the management device 39 determines whether the communication unit 49 has received a movement completion notification. The movement completion notification is a notification transmitted by the autonomous vehicle 18 when the autonomous vehicle 18 is parked at the target position. When the parking completion notification has been received, the present process is ended. When the parking completion notification has not been received, the process returns to S25.

[1-2-3. Automatic Parking Process]

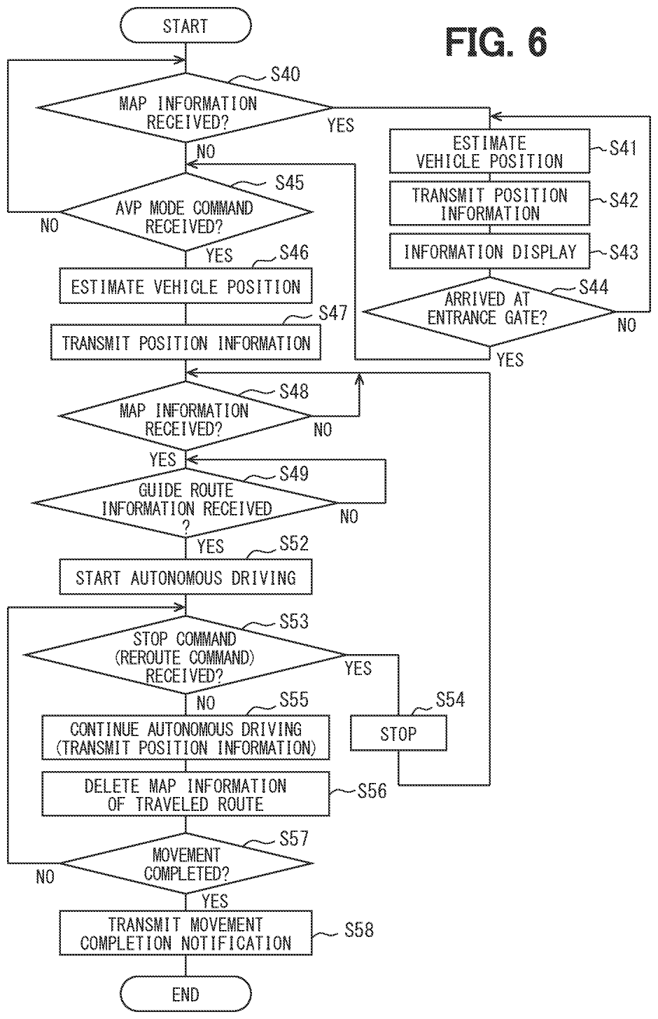

An automatic parking process executed by the autonomous vehicle 18 will be described with reference to FIG. 6. The automatic parking process is a process that is started when communication with the management device 39 is established, and the autonomous vehicle 18 performs autonomous driving according to the movement management process executed by the management device 39. Hereinafter, a process executed by the control unit 69 (particularly the CPU 691) of the autonomous vehicle 18 will also be referred to as a process executed by the autonomous vehicle 18.

First, in S40, the autonomous vehicle 18 determines whether the communication unit 75 has received map information of the parking lot. The map information here is near-side map information. When the map information has been received, the autonomous vehicle 18 estimates the current location of the autonomous vehicle 18 in S41. Subsequently, in S42, the autonomous vehicle 18 transmits the estimation result of the current location to the management device 39 as position information of the autonomous vehicle 18.

Subsequently, in S43, the autonomous vehicle 18 displays any information such as the acquired parking lot map information on a display of the vehicle. Subsequently, the autonomous vehicle 18 determines whether the autonomous vehicle 18 has arrived at the entrance gate 15G. The arrival at the entrance gate 15G can be recognized by the autonomous vehicle 18 through a notification from the management device 39, image processing by the camera of the autonomous vehicle 18, or the like.

When the autonomous vehicle 18 has not arrived at the entrance gate 15G, the process returns to S41. When the autonomous vehicle 18 has arrived at the entrance gate 15G, the process proceeds to S45.

By the way, when the autonomous vehicle 18 has not received the map information in S40, the autonomous vehicle 18 proceeds to S45 and determines whether an AVP mode command has been received. When the AVP mode command has not been received, the process returns to S40.

When the AVP mode command has been received, the autonomous vehicle 18 transitions to an AVP mode and performs the processes in and after S46. That is, the autonomous vehicle 18 estimates the current location of the autonomous vehicle 18 in S46. In S47, the autonomous vehicle 18 transmits the estimation result of the current location to the management device 39 as position information of the autonomous vehicle 18.

Subsequently, the autonomous vehicle 18 determines in S48 whether parking lot map information has been received. The parking lot map information here is map information of any one of the divided first portion 32A, second portion 32B, and third portion 32C related to the guide route.

When the parking lot map information has not been received, the autonomous vehicle 18 repeats S48, and when the map information has been received, the autonomous vehicle 18 determines in S49 whether guide route information has been received. The received map information is updated in the process in S62 that will be described later. The guide route information is information transmitted by the management device 39. In S49, when the guide route information has not been received, the present process repeats S49.

In S46, when the guide route information has been received, the autonomous vehicle 18 starts autonomous driving of the autonomous vehicle 18 in S52. When the autonomous vehicle 18 performs autonomous driving, the autonomous vehicle 18 travels in accordance with the guide route included in the guide route information. In this case, the autonomous vehicle 18 compares positions of a passage, an obstacle, a section, and the like indicated by the map information with positions of a passage, an obstacle, a section, and the like recognized by the autonomous vehicle 18, and correctly recognizes a position of the autonomous vehicle 18.

Subsequently, the autonomous vehicle 18 determines in S53 whether the autonomous vehicle 18 has received a stop command or a reroute command. The stop command or the reroute command is transmitted by the management device 39. When the stop command or the reroute command has been received, the process proceeds to S54, and when the stop command has been received, the autonomous vehicle 18 stops the autonomous vehicle 18. S54 is omitted when the reroute command has been received. Including the case where S54 is omitted, the present process returns to S48 after the process in S54.

In S53, when the autonomous vehicle 18 has not received the stop command or the reroute command, the autonomous vehicle 18 continues to perform autonomous driving in S55. In this case, the autonomous vehicle 18 repeatedly transmits the position information of the autonomous vehicle 18 to the management device 39 until it is determined in S57 that will be described later that parking has been completed. The transmitted position information is received by the management device 39.

Subsequently, in S56, the autonomous vehicle 18 deletes the map information of the traveled route. The function of S56 corresponds to a deletion unit in the present disclosure. The map information of the traveled route represents map information related to the guide route that the autonomous vehicle 18 has already traveled, in the parking lot map information stored in the autonomous vehicle 18. For example, when the autonomous vehicle 18 stores only the map information of the first portion 32A, and the autonomous vehicle 18 has passed through half of the section indicated by the first portion 32A, map information of the half from the memory 692 is deleted.

Alternatively, when the autonomous vehicle 18 stores the map information of the first portion 32A and the second portion 32B, and the autonomous vehicle 18 has passed through the section indicated by the first portion 32A, the map information of the first portion 32A is deleted from the memory 692.

Subsequently, the autonomous vehicle 18 determines whether the movement has been completed in S57. Completion of the movement means that the autonomous vehicle 18 arrives at the target position set in the management device 39. When the movement has not been completed, the process returns to S53.

When the movement has been completed, the process proceeds to S58, the autonomous vehicle 18 uses the communication unit 75 to transmit a movement completion notification, and ends the present process. The management device 39 receives the transmitted movement completion notification.

[1-2-4. Map Information Update Process]

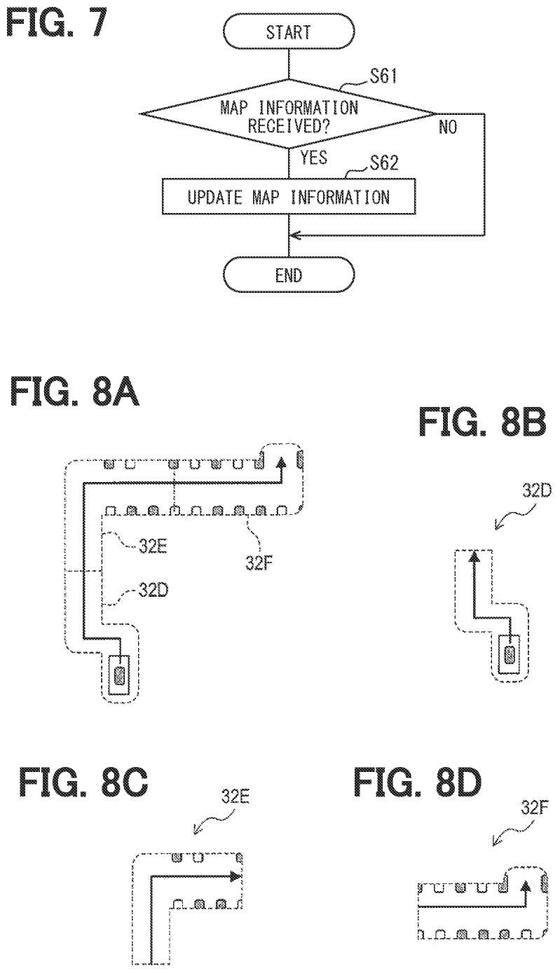

A map information update process executed by the autonomous vehicle 18 will be described with reference to FIG. 7. The map information update process is a process that is repeatedly executed when the autonomous vehicle 18 is powered on.

In the map information update process, first, in S61, the autonomous vehicle 18 determines whether parking lot map information has been received. The parking lot map information here is a divided map such as a near-side map or map information of the first portion 32A.

When the parking lot map information has not been received in S61, the present process is ended. When the parking lot map information has been received in S61, the autonomous vehicle 18 stores the parking lot map information in the memory 692 in S62. The function of S62 corresponds to a storage unit in the present disclosure. In this case, in addition to the parking lot map information already stored in the memory 692, the received new parking lot map information is stored in the memory 692. However, when rerouting is performed, the parking lot map information already stored in the memory 692 may be deleted.

[1-3. Advantageous Effects]

According to the first embodiment described in detail above, the following effects are achieved.

(1a) One aspect of the present disclosure is the parking assistance system 1 configured to assist in automatic valet parking of a vehicle, and includes the autonomous vehicle 18, the management device 39, and the terminal device 43. The autonomous vehicle 18 is configured to perform autonomous driving between the boarding-alighting areas 3 and 5 in the parking lot and a parking position. The management device 39 is configured to manage entering and exiting of the autonomous vehicle 18 in the parking lot. The terminal device 43 is configured to be operable by a user.

The management device 39 includes the route generation unit 47A, the first map provision unit 47B, and the route provision unit 47C. When the intention to load the autonomous vehicle 18 is input from the terminal device 43 while the autonomous vehicle 18 is located in the boarding-alighting areas 3 and 5, the route generation unit 47A is configured to generate a guide route from the boarding-alighting areas 3 and 5 to the parking position that is a target position.

The first map provision unit 47B is configured to extract a route map representing parking lot map information of a portion related to the guide route from the previously prepared parking lot map information including positions of a passage of the parking lot, the boarding-alighting areas 3 and 5, and the parking position and provide the route map to the autonomous vehicle 18. The route provision unit 47C is configured to provide the guide route to the autonomous vehicle 18.

According to such a configuration, the management device 39 transmits only the route map related to the guide route out of the parking lot map information to the autonomous vehicle 18, and thus the autonomous vehicle 18 does not need to store all of the parking lot map information. Therefore, when the parking lot map information is stored in the autonomous vehicle 18, it is possible to restrict a capacity of the memory 692 of the autonomous vehicle 18 from becoming tight.

(1b) In one aspect of the present disclosure, the first map provision unit 47B is configured to use multiple divided guide routes as multiple divided routes, extract parking lot map information of portions related to the divided routes as multiple divided maps obtained by dividing the route map, and provide the autonomous vehicle 18 with the multiple divided maps in descending order of distance from the target position in accordance with movement of the autonomous vehicle 18.

According to such a configuration, since the divided maps, which are divided parking lot map information, are sequentially provided in accordance with movement of the autonomous vehicle 18, a capacity of the parking lot map information to be stored in the autonomous vehicle 18 can be further reduced. Therefore, it is possible to further restrict the tightness of the memory capacity of the autonomous vehicle 18.

(1c) In one aspect of the present disclosure, the second map provision unit 47D is configured to extract a near-side map representing parking lot map information of a portion from a near-side region to the boarding-alighting areas 3 and 5 from the parking lot map information when the autonomous vehicle 18 is located in the near-side region set in advance before the entering intention is input and before the autonomous vehicle 18 arrives at the boarding-alighting areas 3 and 5, and provide the near-side map to the autonomous vehicle 18.

According to such a configuration, the management device 39 transmits the near-side map before the autonomous vehicle 18 arrives at the boarding-alighting areas 3 and 5, and can thus perform any other processes before the autonomous vehicle 18 arrives at the boarding-alighting areas 3 and 5. For example, the management device 39 can perform any check process as a process using the near-side map in a near-side region such as the entrance gate 15G. More specifically, an operation check for autonomous driving during manual driving, checking of a self-position estimation and accuracy check, checking of tilting of a camera or a sensor, checking of hardware or an application, and the like can be performed.

(1d) In one aspect of the present disclosure, the autonomous vehicle 18 is configured to pass through the entrance gate 15G that separates the inside and the outside of the parking lot from the outside of the parking lot and head for the boarding-alighting areas 3 and 5 with manual driving by a user. The communication establishment unit 47E of the management device 39 is configured to establish communication in a near-side region set outside the gate. The second map provision unit 47D is configured to extract a near-side map and provide the near-side map to the autonomous vehicle 18 when communication is established.

According to such a configuration, since the management device 39 starts to transmit the near-side map when communication with the autonomous vehicle 18 is established, the processing waiting time at the entrance gate 15G can be reduced when there is a procedure such as checking to be completed at the entrance gate 15G.

(1e) In one aspect of the present disclosure, the autonomous vehicle 18 is configured to store the route map in the memory 692 upon receiving the route map from management device 39. The autonomous vehicle 18 is configured to delete, from the memory 692, a portion in the route map in which the autonomous vehicle 18 has finished traveling.

According to such a configuration, since the autonomous vehicle 18 deletes, from the memory, the portion in the route map in which the autonomous vehicle 18 has finished traveling, it is possible to further reduce a capacity of the memory 692 of the autonomous vehicle 18 from becoming tight.

(1f) In one aspect of the present disclosure, when the route generation unit 47A is configured to generate a new guide route from the current location of the autonomous vehicle 18 to a changed target position upon receiving a reroute command for changing the guide route. The first map provision unit 47B is configured to extract parking lot map information of a portion related to the new guide route as a route map, and provide the route map to the autonomous vehicle 18.

According to such a configuration, even when the guide route is rerouted, the management device 39 transmits the route map related to the new guide route to the autonomous vehicle 18, and thus it is possible to provide the necessary and sufficient route map to the autonomous vehicle 18.

(1g) In one aspect of the present disclosure, each of the multiple divided maps provided by the first map provision unit 47B, excluding the divided map to be provided last to the autonomous vehicle 18, is configured to include update positions. A guide route divided into multiple routes is defined as multiple divided routes, and parking lot map information of portions related to the divided routes is defined as multiple divided maps obtained by dividing the route map.

The first map provision unit 47B is configured to provide the multiple divided maps to the autonomous vehicle 18 in descending order of distance from the target position in accordance with movement of the autonomous vehicle 18. The first map provision unit 47B is configured to determine whether the autonomous vehicle 18 has reached the update position, and provide the next divided map when it is determined that the autonomous vehicle 18 has reached the update position.

According to such a configuration, since the next divided map is provided every time the autonomous vehicle 18 arrives at the update position in the divided map, it is possible to restrict a large number of divided maps from being transmitted to the autonomous vehicle 18. Therefore, it is possible to restrict the memory capacity of the autonomous vehicle 18 from becoming tight.

(1h) In one aspect of the present disclosure, the management device 39 is configured to acquire information regarding a magnitude of a capacity of the memory of the autonomous vehicle 18 from the autonomous vehicle 18 when communication with the autonomous vehicle 18 is established.

According to such a configuration, the memory capacity of the autonomous vehicle 18 is sent to the management device 39. Therefore, the management device 39 can provide the parking lot map information after recognizing the memory capacity of the autonomous vehicle 18.

(1i) In one aspect of the present disclosure, the route map includes position information of a passage of the parking lot, the boarding-alighting areas 3 and 5, and the parking area 7, and position information of a target object including at least any of an obstacle, a marker, and a lane line that can be sensed by sensors of the autonomous vehicle 18.

According to such a configuration, since the route map includes the position information of the target object that can be sensed by the sensors of the autonomous vehicle 18, the management device 39 can compare the position information of the target object sensed by the autonomous vehicle 18 with the position information of the target object in the route map. Therefore, the management device 39 can recognize a position of the autonomous vehicle 18 with higher accuracy.

### 2. Other Embodiments

Although the embodiment of the present disclosure has been described above, the present disclosure is not limited to the above embodiment, and can be realized in various modifications.

(2a) In the above embodiment, the management device 39 divides the parking lot map information regarding the guide route and provides the divided map information to the autonomous vehicle 18, but the present disclosure is not limited to this. For example, the management device 39 may transmit the parking lot map information related to the guide route as one piece of map information (referred to as partial map information) without dividing the parking lot map information.

(2b-1) In the above embodiment, the management device 39 transmits a divided map obtained by dividing the route map each time the autonomous vehicle 18 travels a predetermined distance along the guide route, the present disclosure is not limited to this. For example, the management device 39 may transmit a divided map each time the autonomous vehicle 18 travels for a predetermined period of time. A magnitude of a data capacity of the divided map, for example, the number of divisions of the route map may be determined according to a magnitude of a capacity of the memory 692 of the autonomous vehicle 18. The divided map may be transmitted earlier as a communication speed becomes lower.

The management device 39 may acquire information region the magnitude of the capacity of the memory 692 when communication with the autonomous vehicle 18 is established. The management device 39 preferably has a function of recognizing the speed of communication with the autonomous vehicle 18. Alternatively, the management device 39 may acquire information regarding a file size of map information that can be stored by the autonomous vehicle 18.

(2b-2) That is, in one aspect of the present disclosure, the management device 39 may be configured to acquire information regarding the file size of the route map that can be stored in the autonomous vehicle 18 from the autonomous vehicle 18.

According to such a configuration, the file size of the route map that can be stored in the autonomous vehicle 18 is sent to the management device 39. Therefore, the management device 39 can provide the parking lot map information after recognizing the file size of the route map that can be stored in the autonomous vehicle 18. Although a timing at which the management device 39 acquires the file size information is freely selected, the management device 39 is preferably configured to acquire the file size information before providing the route map to the autonomous vehicle 18.

(2c) In the above embodiment, the route map transmitted by the management device 39 to the autonomous vehicle 18 is map information of the parking lot along the set guide route, but the present disclosure is not limited to this. For example, the management device 39 may divide and store the parking lot map information in advance, and extract divided map information to include the guide route.

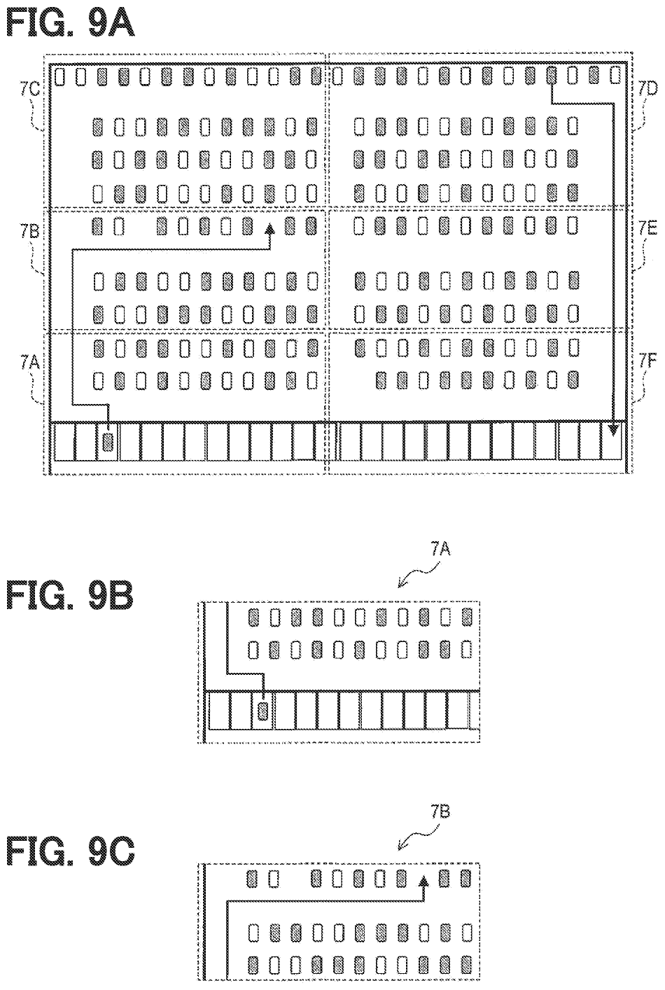

FIGS. 9A, 9B, and 9C illustrate parking lot map information related to a guide route. As illustrated in FIG. 9A, for example, the management device 39 divides the parking lot map of the parking lot into six areas 7A, 7B, 7C, 7D, 7E, and 7F and stores the divided areas. After setting the guide route for the autonomous vehicle 18, the management device 39 extracts divided maps for the areas 7A and 7B that are divided maps including the guide route as illustrated in FIGS. 9B and 9C.

The divided map for the area 7A illustrated in FIG. 9B corresponds to a first portion, and the divided map for the area 7B illustrated in FIG. 9C corresponds to a second portion. The management device 39 transmits the divided map for the area 7A and then transmits the divided map for the area 7B to the autonomous vehicle 18.

When the map information can be transmitted as one file by calculating a file size of the map information corresponding to the guide route, it is not necessary to divide the map information into multiple files. Map information obtained by combining the map information for the area 7A with the map information for the area 7B may be transmitted to the autonomous vehicle 18.

(2d) The control unit 47 and the method thereof described in the present disclosure may be implemented by a dedicated computer that is provided by configuring a processor and memory programmed to execute one or more functions embodied by a computer program. Alternatively, the control unit 47 and the method thereof described in the present disclosure may be realized by a dedicated computer provided by including a processor with one or more dedicated hardware logic circuits. Alternatively, the control unit 47 and the method thereof described in the present disclosure may be realized by one or more dedicated computers configured by a combination of a processor and a memory programmed to execute one or multiple functions and a processor configured by one or more hardware logic circuits. The computer programs may also be stored in a computer readable non-transitory tangible recording medium as computer executable instructions. A method for realizing the functions of each unit included in the control unit 47 does not necessarily include software, and all the functions may be realized by using one or multiple pieces of hardware.

(2e) The multiple functions of one constituent element in the above embodiments may be realized by multiple constituent elements, or a function of one constituent element may be realized by multiple constituent elements. Multiple functions of multiple constituent elements may be realized by one constituent element, or one function realized by multiple constituent elements may be realized by one constituent element. A part of the configuration of the above embodiment may be omitted. At least a part of the configuration of the above embodiment may be added to or substituted for the configuration of the other embodiment.

(2f) In addition to the parking assistance system 1 described above, the present disclosure can be implemented in various forms, for example, a device such as the management device 39 having the parking assistance system 1 as a constituent element or the autonomous vehicle 18, a program for causing a computer to function as the device, a non-transitory tangible storage medium such as a semiconductor memory recording the program, and a parking assistance method.

1. A parking assistance system configured to assist in automatic valet parking of a vehicle, the parking assistance system comprising:
an autonomous vehicle configured to perform autonomous driving between a boarding-alighting area and a parking area in a parking lot; and
a management device configured to manage entering and exiting of the autonomous vehicle in the parking lot, wherein
the management device includes:
a route generation unit configured to generate a guide route from the boarding-alighting area to the parking area that is a target position when an entering instruction for the autonomous vehicle to park is input while the autonomous vehicle is located in the boarding-alighting area;
a map provision unit configured to (i) extract a route map from previously prepared parking lot map information including position information of a passage of the parking lot, the boarding-alighting area, and the parking area and (ii) provide the route map to the autonomous vehicle, the route map being indicative of a portion of the parking lot map information regarding the guide route; and
a route provision unit configured to provide the guide route to the autonomous vehicle,
the map provision unit is a first provision unit, and
the management device further includes a second provision unit configured to provide the autonomous vehicle with a near-side map indicative of a portion of the parking lot map information from a near-side region set in advance to the boarding-alighting area when the autonomous vehicle is located in the near-side region and before the entering instruction is input and the autonomous vehicle arrives at the boarding-alighting area.

2. The parking assistance system according to claim 1, wherein
the map provision unit is configured to:
divide the guide route into a plurality of divided routes;
extract a portion of the parking lot map information regarding the divided routes as a plurality of divided maps; and
provide the plurality of divided maps to the autonomous vehicle in descending order of distance from the target position in accordance with movement of the autonomous vehicle.

3. The parking assistance system according to claim 1, wherein
the parking lot includes a gate that separates an inside of the parking lot from an outside of the parking lot,
the near-side region is located outside of the gate,
the autonomous vehicle is configured to pass through the gate from the outside of the parking lot and travel to the boarding-alighting area with manual driving by a user,
the management device further includes a communication establishment unit configured to establish communication in the near-side region, and
the second provision unit is configured to provide the near-side map to the autonomous vehicle when the communication is established.

4. The parking assistance system according to claim 1, wherein
the autonomous vehicle includes:
a storage unit configured to store the route map in a memory upon receiving the route map from the management device, and
a deletion unit configured to delete, from the memory, a portion of the route map for which the autonomous vehicle has finished traveling.

5. The parking assistance system according to claim 1, wherein
the route generation unit is configured to generate a new guide route from a current location of the autonomous vehicle to a changed target position upon receiving a reroute command for changing the guide route, and
the map provision unit is configured to:
extract a portion of the parking lot map information regarding the new guide route as the route map; and
provide the extracted route map to the autonomous vehicle.

6. A parking assistance device configured to assist in automatic valet parking of a vehicle, the vehicle being an autonomous vehicle configured to perform autonomous driving between a boarding-alighting area and a parking area in a parking lot, the parking assistance device comprising:
a route generation unit configured to generate a guide route from the boarding-alighting area to the parking area that is a target position when an entering instruction for the autonomous vehicle to park is input while the autonomous vehicle is located in the boarding-alighting area;
a map provision unit configured to (i) extract a route map from previously prepared parking lot map information including position information of a passage of the parking lot, the boarding-alighting area, and the parking area and (ii) provide the route map to the autonomous vehicle, the route map being indicative of a portion of the parking lot map information regarding the guide route; and
a route provision unit configured to provide the guide route to the autonomous vehicle, wherein
the map provision unit is a first provision unit, and
the parking assistance device further includes a second provision unit configured to provide the autonomous vehicle with a near-side map indicative of a portion of the parking lot map information from a near-side region set in advance to the boarding-alighting area when the autonomous vehicle is located in the near-side region and before the entering instruction is input and the autonomous vehicle arrives at the boarding-alighting area.

7. The parking assistance device according to claim 6, wherein
the guide route is divided into a plurality of divided routes, and
a plurality of divided maps are defined as each being indicative of a portion of the parking lot map information regarding a respective one of the plurality of divided routes,
each of the plurality of divided maps, excluding a last one of the divided maps to be provided last to the autonomous vehicle, includes an update position, and
the map provision unit is configured to:
provide the plurality of divided maps to the autonomous vehicle in descending order of distance from the target position in accordance with movement of the autonomous vehicle;
determine whether the autonomous vehicle has reached the update position in each of the plurality of divided maps; and
provide a next divided map of the plurality of divided maps upon determining that the autonomous vehicle has reached the update position in a current divided map of the plurality of divided maps.

8. The parking assistance device according to claim 6, wherein
when communication with an autonomous vehicle is established, the parking assistance device is configured to acquire, from the autonomous vehicle, information regarding a capacity of a memory of the autonomous vehicle.

9. The parking assistance device according to claim 6, wherein
the parking assistance device is configured to acquire, from the autonomous vehicle, information regarding a file size of the route map that is a storable size in the autonomous vehicle.

10. The parking assistance device according to claim 6, wherein
the route map includes position information of a passage of the parking lot, the boarding-alighting area, the parking area, and position information of a target object including at least one of an obstacle, a marker, and a lane line that are sensible by a sensor of the autonomous vehicle.

11. A parking assistance method executed by a parking assistance device configured to assist in automatic valet parking of a vehicle, the vehicle being an autonomous vehicle configured to perform autonomous driving between a boarding-alighting area and a parking area in a parking lot, the parking assistance method comprising:
generating a guide route from the boarding-alighting area to the parking area that is a target position when an entering instruction for the autonomous vehicle to park is input while the autonomous vehicle is located in the boarding-alighting area;
extracting a route map from previously prepared parking lot map information including position information of a passage of the parking lot, the boarding-alighting area, and the parking area and providing the route map to the autonomous vehicle, the route map being indicative of a portion of the parking lot map information regarding the guide route; and
providing the guide route to the autonomous vehicle; and
providing the autonomous vehicle with a near-side map indicative of a portion of the parking lot map information from a near-side region set in advance to the boarding-alighting area when the autonomous vehicle is located in the near-side region and before the entering instruction is input and the autonomous vehicle arrives at the boarding-alighting area.

12. A non-transitory computer readable medium storing a parking assistance program executed by a computer mounted in a parking assistance device that is configured to assist in automatic valet parking of a vehicle, the vehicle being an autonomous vehicle configured to perform autonomous driving between a boarding-alighting area and a parking area in a parking lot, the parking assistance program comprising instructions, when executed by the computer, causing the computer to:
generate a guide route from the boarding-alighting area to the parking area that is a target position when an entering instruction for the autonomous vehicle to park is input while the autonomous vehicle is located in the boarding-alighting area;
extract a route map from previously prepared parking lot map information including position information of a passage of the parking lot, the boarding-alighting area, and the parking area, the route map being indicative of a portion of the parking lot map information regarding the guide route;
provide the route map to the autonomous vehicle;
provide the guide route to the autonomous vehicle; and
provide the autonomous vehicle with a near-side map indicative of a portion of the parking lot map information from a near-side region set in advance to the boarding-alighting area when the autonomous vehicle is located in the near-side region and before the entering instruction is input and the autonomous vehicle arrives at the boarding-alighting area.
